(19) United States
(12) Patent Application Publication
(10) Pub. No.: US 2014/0064707 A1
(43) Pub. Date: Mar. 6, 2014

(54) SCENE SCHEDULING SYSTEM, SCENE SCHEDULING METHOD, AND RECORDING MEDIUM THEREOF

(71) Applicant: INSTITUTE FOR INFORMATION INDUSTRY, Taipei City (TW)

(72) Inventors: Chia-Hsiang CHANG, Taipei City (TW); Jing-Fung CHEN, New Taipei City (TW); Emery JOU, Taipei City (TW); Yueh-Ying CHANG, Taipei City (TW)

(73) Assignee: INSTITUTE FOR INFORMATION INDUSTRY, Taipei City (TW)

(21) Appl. No.: 13/671,182

(22) Filed: Nov. 7, 2012

(30) Foreign Application Priority Data
Aug. 31, 2012 (TW) 101131768

(51) Int. Cl. H04N 5/76

(52) U.S. Cl. 386/291; 386/E05.003

(57) ABSTRACT

A scene scheduling system, a scene scheduling method, and a recording medium thereof are provided. This system includes a medium providing module, an input module, a time scheduling unit and a medium capture module. The medium providing module is used for providing medium data and ad medium data corresponding thereto. The input module is used for inputting a channel setting signal. The time scheduling unit provides a piece of preset time scheduling data, and adjusts the preset time scheduling data according to the channel setting signal, so as to form a piece of personalization time scheduling data. The medium capture module captures the medium data and the a piece of ad medium data corresponding to the channel setting signal and the personalization time scheduling data from the medium providing module according to the personalization time scheduling data.

### CROSS-REFERENCE TO RELATED APPLICATION

This application claims the benefit of Taiwan Patent Application No. 101131768, filed on Aug. 31, 2012, which is hereby incorporated by reference for all purposes as if fully set forth herein.

### BACKGROUND

1. Field of Invention

The present invention relates to an ad scene scheduling system, an ad scene scheduling method and a recording medium thereof, and particularly to a scene scheduling system, a scene scheduling method and a recording medium thereof in which through time scheduling, an ad medium is interspersed during medium play.

2. Related Art

A conventional wireless television station transmits a television program in a wireless broadcast manner, and as long as a viewing subscriber sets up an antenna, the viewing subscriber may view the television program. The program is publicly broadcasted in the wireless transmission manner, and the program making and playing expenditure, the operating cost and even the profit of the wireless television station completely come from the ad expense paid by an advertiser who entrusts the ad play to the wireless television station, so an ad is always inserted in a television program transmitted by the wireless television station. After the wired television system rises abruptly, if a viewing subscriber intends to watch a wired television program, the viewing subscriber must establish a cable between the viewing subscriber and the wired television system to transfer the video program, and can view the video program only when the viewing subscriber pays the monthly fee; the wired television is viewed by the subscriber after payment, but in order to reduce the making and playing cost and increase the profit, the channel supplier still inserts an ad in the program.

It can be known from the above description that, no matter whether it is the wired television station or wireless television station, the ad is always an important financial source on the running. As far as the advertiser is concerned, the reason why the advertiser is willing to entrust the ad play lies in that the television transmission system has a stable and enormous viewing group and has a high ad benefit. However, the existing television ad play manner still has some congenital limitations:

1. Time limitation: the inserted ad is subject to the restraint of the radio and television regulation, so the inserted ad must amount to a proportion less than a certain proportion of the total length of a normal play program, for example, in a program of one hour, the total time of an inserted ad cannot exceed 15 minutes.

2. Presentation space limitation: expenses of play entrustment of a television ad are extremely high, so an ad clip is generally very short, and therefore, the content of the ad clip must completely and clearly present the promotion theme of the ad commodity in an extremely short time, which is not only a very large challenge for the ad designer, but also makes people inevitably doubt what can be left in the mind of the viewer in the fleeting ad clip?

### SUMMARY

In order to solve the above problem, the present invention discloses a scene scheduling system, a scene scheduling method and a recording medium thereof in which the time scheduling is used as an ad play basis, and through the time sequencing, the captured medium and ad medium are sequentially played, so as to achieve increase of the advertising benefit.

The scene scheduling system disclosed in the present invention comprises a medium providing module, an input module, a time scheduling unit and a medium capture module.

This medium providing module is used for providing a piece of medium data and a piece of ad medium data. The input module is used for inputting a channel setting signal. The time scheduling unit provides a piece of preset time scheduling data, and adjusts the preset time scheduling data according to the channel setting signal, so as to form a piece of personalization time scheduling data. The medium capture module is used for capturing the medium data and the piece of ad medium data corresponding to the time scheduling data from the medium providing module according to the time scheduling data.

The scene scheduling method disclosed in the present invention comprises: providing, by a medium providing module, a piece of medium data and a piece of ad medium data; providing, by a time scheduling data module, a piece of preset time scheduling data; inputting, by an input module, a channel setting signal; then adjusting, by the time scheduling data module, the preset time scheduling data according to the channel setting signal, so as to form a piece of personalization time scheduling data; and then capturing, by a medium capture module, the medium data and the piece of ad medium data corresponding to the personalization time scheduling data from the medium providing module according to the personalization time scheduling data.

The present invention further discloses a recording medium, which is provided for an electronic device to execute the foregoing scene scheduling method, and the method step process thereof is the same as what is illustrated above, and is not repeated herein.

The present invention is characterized in that, through play schedules of various programs, a corresponding ad is captured and played for attributes of a user watching a program, and the user does not need to consume time to watch the ad content not conforming to the attributes of the user. Secondly, by capturing the targeted ad medium data, the user may increase the accuracy of obtaining the required ad medium data according to manipulation of an individual on the ad medium data played by a multimedia play apparatus, namely, it is not limited to the fixed ad play content. Thirdly, through the targeted ad play content, the user obtains the required ad medium data, so the limitation of the conventional television ad on the time and presentation form may be broken through, thereby effectively enlarging the ad benefit.

### BRIEF DESCRIPTION OF THE DRAWINGS

The present invention will become more fully understood from the detailed description given herein below for illustration only, and thus are not limitative of the present invention, and in which:

FIG. 1 shows a scene scheduling system of an embodiment of the present invention;

FIG. 2 shows another scene scheduling system of an embodiment of the present invention is shown;

FIG. 3 shows a perspective diagram of a first detailed architecture of a scene scheduling system according to an embodiment of the present invention;

FIG. 4 shows a perspective diagram of a second detailed architecture of a scene scheduling system according to an embodiment of the present invention;

FIG. 5 shows a perspective diagram of a third detailed architecture of a scene scheduling system according to an embodiment of the present invention;

FIG. 6 shows a perspective diagram of a fourth detailed architecture of a scene scheduling system according to an embodiment of the present invention;

FIG. 7 shows a perspective diagram of a fifth detailed architecture of a scene scheduling system according to an embodiment of the present invention;

FIG. 8 shows a perspective flowchart corresponding to the scene scheduling method of FIG. 1 is shown;

FIG. 9 shows a perspective flowchart corresponding to another scene scheduling method of FIG. 2; and

FIG. 10 to FIG. 14 show a perspective diagram of a detailed process of a scene scheduling method of an embodiment of the present invention.

### DETAILED DESCRIPTION

Preferred embodiments of the present invention are illustrated in cooperation with the drawings as follows.

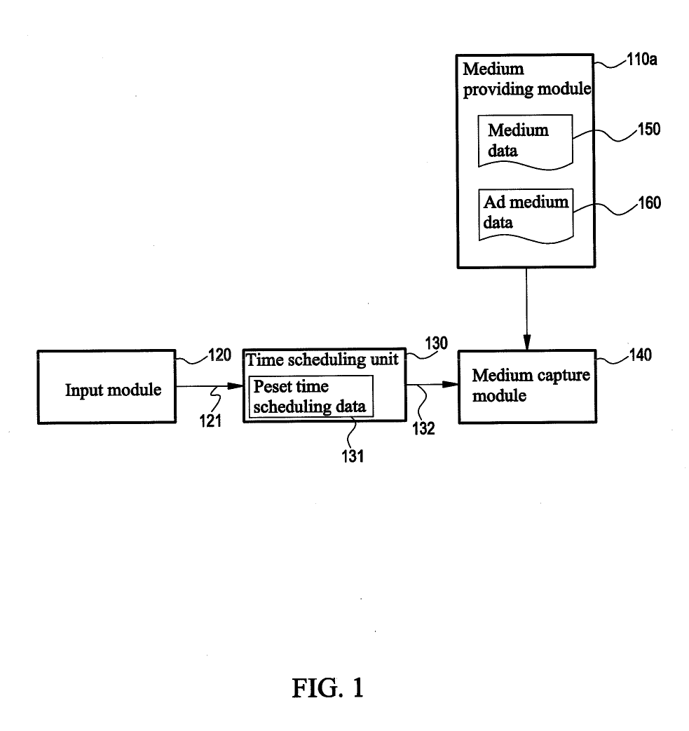

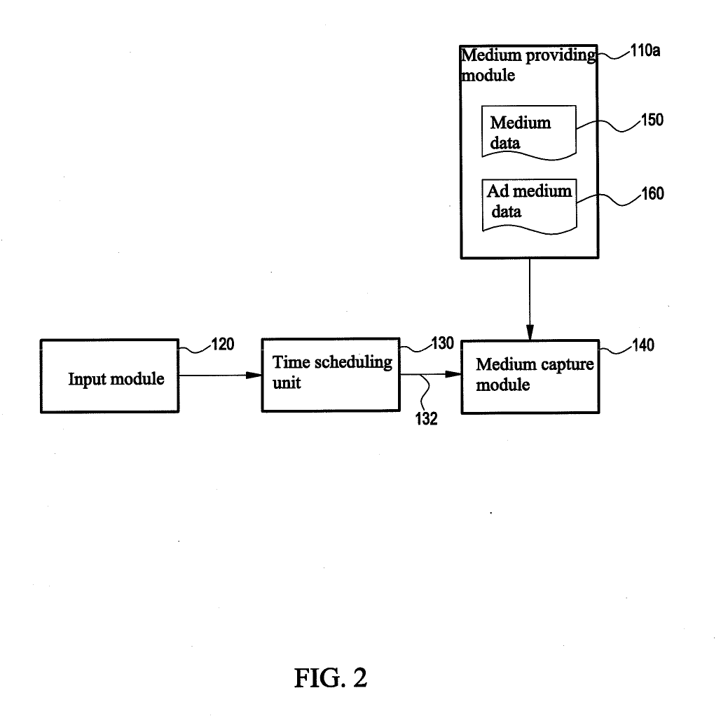

Firstly, referring to FIG. 1, a scene scheduling system of an embodiment of the present invention is shown. FIG. 2 shows another scene scheduling system of an embodiment of the present invention is shown. The systems in FIG. 1 and FIG. 2 are applied to an apparatus, a device or a system having a medium play capability, and the configuration form is not limited. This scene scheduling system includes a medium providing module 110a, an input module 120, a time scheduling unit 130 and a medium capture module 140.

The medium providing module 110a is used for providing a piece of medium data 150 and more than one piece of ad medium data 160. This medium providing module 110a refers to hardware having a medium supply capability, or is formed of at least more than one form of a unit, a component, an apparatus, a device and a system formed through the combination of software and hardware.

The medium data 150 is formed through the combination of several scenes, and each scene is a meaningful unit formed of multiple media frames. For example, during a baseball match, a striker strikes a ball to make the ball pass through a home-run wall, so as to form a home-run clip film, namely, one scene in the match. The source of the medium data may include a mixing module of several channels, such as: the HBO, a film channel, and a variety channel, and as far as an individual program in each channel is concerned, a scene is used as the minimum unit. The ad medium data 160 is data for providing the corresponding medium data 150 or for propagandizing a media frame included in the medium data 150, such as, data for further narrating the media frame, which is similar to the brief description, the play time, the title and so on of the play content of the media frame.

The input module 120 is used for a user to input a channel setting signal 121, namely, for a user to input a data input interface of data, and the presentation end of this interface depends on demands of a designer and is not limited.

The medium data 150 includes multiple media frames with different contents, for example, when the medium data 150 is image data, basic descriptive data of the image data includes an image frame having more than one content of title, scene, character, subtitle and so on, and it can be known from this description that, each image frame is formed through the combination of more than one piece of metadata. However, an ordinary video receiving manner allows to receive a stream having an image and a sound simultaneously, or to separately receive a film signal and a sound signal.

Also, if the medium data 150 is voice data, the sliced time and the scene defined by the voice data are the same, the timestamp and the scene in the data are adopted to be calibrated into several voice sections, and the detailed description thereof is about the voice metadata of more than one content of high-pitched voice, low-pitched voice, voice sound, music sound and so on.

The channel setting signal 121 refers to a capture demand condition input by a user on which the user intends to capture a specific media frame from the medium data 150. For example, when the medium data 150 is a recorded image of a basketball match, a user inputs a capture demand condition such as shooting and scoring pictures of a favorite player thereof, or three-point line shooting and scoring pictures of all players of this match, or three-point shooting and scoring pictures of a favorite player thereof. Also for example, when the medium data 150 is music data of an opera, a user inputs a capture demand condition such as a solo of a leading lady of the opera, or performance of a pure music clip.

The time scheduling unit 130 provides preset time scheduling data 131, and adjusts preset time scheduling data 131 according to the channel setting signal 121 input by the input module 120, so as to form personalization time scheduling data 132 (as shown in FIG. 1). In other words, if a user does not perform a channel switching action at the time of using an apparatus, a device or a system having a medium play capability to watch a multimedia video and audio program, the time scheduling unit 130 only provides the preset time scheduling data 131 to the medium capture module 140 (as shown in FIG. 2).

Still further, in each piece of preset time scheduling data or personalization time scheduling data, the play time of the medium data and the play time of a piece of ad medium data each amount to a preset play time proportion. For example, whenever a television program (medium data) is played, an ad (ad medium data) of 1 and ⅔ minutes must be played. The ad medium is the same as the medium data, each ad medium is formed through the combination of ad units with undetermined lengths in an ad package, each ad unit includes several ad scenes, each ad scene is a meaningful unit formed of multiple media frames, and each media frame is formed through the combination of more than one piece of metadata.

It should be noted that, the personalization time scheduling data includes a front end personalization time sequence and a rear end personalization time sequence, and in the front end personalization time sequence, the medium capture module only captures the medium data corresponding to the personalization time scheduling data. In other words, after a user switches a channel, only medium data (namely, program content) is played in the first 5 minutes (the front end personalization time sequence), and after 5 minutes, the front end personalization time sequence is switched into the rear end personalization time sequence, namely, according to the medium play arrangement manner of the original preset time scheduling data, namely, whenever a television program (medium data) is played, an ad (ad medium data) of 1 and ⅔ minutes must be played.

Moreover, the preset time scheduling data may also be used as the basis on which the currently watched data is adjusted according to the use weight of the user, namely, according to the use record previously watched by the user, and the adjusting manner may be to use the historical watching record of the user as the basis of the current preset time scheduling data through a conventional Bayes classifier and a hidden Markov model or according to the rate monotonic scheduling (RMS), so as to achieve the objective of quickly presenting personalization time scheduling.

The historical watching record is divided into two attributes: ad watching and program concern, so as to respectively record watching time and content, but the system will also push and watch a current friend recommended watching program and a hot program simultaneously, so at the time of performing scheduling, the friend recommended watching program and the hot program will also become a reference value of the scheduling.

The medium capture module 140 is formed of software, hardware or both software and hardware, such as an application soft executed by an operational processor, a chip, an integrated circuit (IC), or still further firmware in cooperation with the running of a chip or integrated circuit, is not limited, and depends on demands of the designer.

This medium capture module 140 obtains the medium data 150 and the ad medium data 160 provided by the medium providing module 110a, and obtains the channel setting signal 121 from the input module 120. The medium capture module 140 compares a capture demand condition of the channel setting signal 121 and each piece of ad medium data 160, so as to obtain more than one piece of target ad medium data 160, and then captures all target media frames corresponding to the target ad medium data 160 from the obtained medium data 150. However, the channel setting signal 121 may not merely include one capture demand condition, and may also include various different capture demand conditions. The medium capture module 140 captures multiple media frame groups from the medium data 150 according to each capture demand condition.

The medium capture module 140 may construct each captured target media frame into one or more self-built media according to similar rules such as the play sequence, the play time of the media frame in the medium data 150, and the sequence of the capture demand conditions. Alternatively, much further, a medium play tree structure is constructed according to the data dependence of each capture demand condition or the category of the data attribute. However, the interface of the input module 120 presents the input field of the medium play tree structure, and the user inputs each capture demand condition into each field only according to the data dependence of each capture demand condition or the category of the data attribute, so as to be provided as the basis on which the medium capture module 140 captures and classifies the media frames.

However, the medium providing module 110a provides a plurality of pieces of medium data 150, provides the ad medium data 160 corresponding to each piece of the medium data 150, and provides the medium data 150 and the ad medium data 160 together to the medium capture module 140. When using the input module 120 to input the channel setting signal 121, the user may set different capture demand conditions for each piece of the medium data 150, or set a capture demand condition for all the medium data 150, which depends on demands of the user. The medium capture module 140 compares relevant ad medium data 160 according to the channel setting signal 121, so as to find the target ad medium data 160, and then captures a target media frame from each piece of the medium data 150 according to the target ad medium data 160.

Next, the medium capture module 140 is designed to construct the target media frame and even further, the aforementioned media frame group formed of a target media frame into a play medium conforming to user demands.

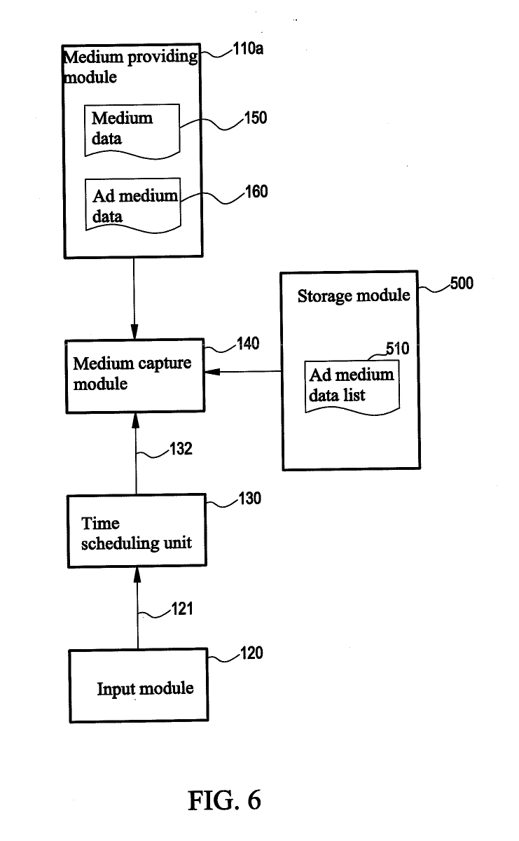

However, capture results such as the target media frame, the media frame group, the target ad medium data 160, the medium play tree structure, and the play medium are stored in a storage module 500 (as shown in FIG. 6) by the medium capture module 140, so as to be used by the medium capture module 140 at the time of performing a next capture operation. Even further, the play medium constructed through the medium capture operation may be directly accessed and played by a play module of the system.

At current, a viewing habit of an ordinary user for watching a program is to switch the channel as long as an ad occurs, and after the channel switching, to continue to switch the channel once an ad is seen. However, the main source of the revenue of an ordinary television program is the ad, and therefore, although the cost of the ad play entrustment manner of the conventional wired/wireless television is high, the effect is dubious. However, as far as the advertiser paying attention to enormous viewing subscribers is concerned, the ad play entrustment manner is still the only preferable choice currently. However, when the digital television era is forthcoming, an opportunity for solving the aforementioned problem occurs.

It is generally known that, the digital television is comprehensively played, the so-called digital television is different from the conventional analog television in the signal form, and the most major superiority thereof lies in that information is diversified. In addition to supporting various access manners, the digital television uses the IP and owns various encoding/decoding functions, and may further provide service functions such as video on-demand, network browsing, and interactive game, so as to form a domestic digital platform of a digital television system and further be expanded into an interactive multimedia digital content service. Under the conditions, an ad play manner both conforming to user demands and increasing the ad benefit may be provided through the scene scheduling design of this application.

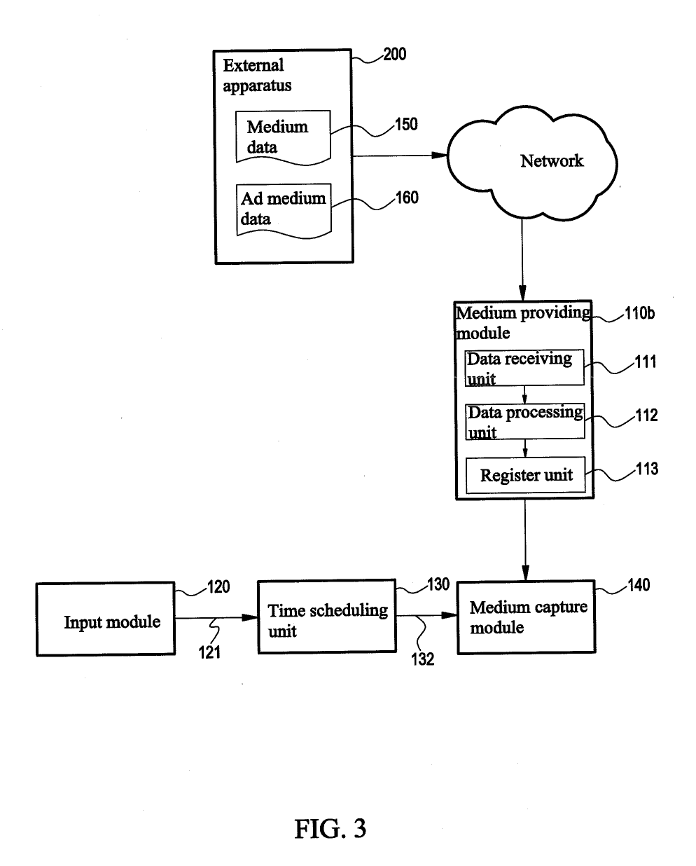

Referring to FIG. 3, a perspective diagram of a first detailed architecture of a scene scheduling system according to an embodiment of the present invention is shown. In this example, a medium providing module 110b includes a data receiving unit 111 and a data processing unit 112. The data receiving unit 111 itself is not stored with medium data 150 and ad medium data 160, and obtains the medium data 150 and the ad medium data 160 by being connected to an external apparatus 200 or through a network, and the obtained medium data 150 and ad medium data 160 are provided to a medium capture module 140. The obtained medium data 150 may be stream media or whole video and audio data.

When the medium data 150 is the stream media, the data processing unit 112 directly transmits the received media frame or medium clip to the medium capture module 140, so as to make the medium capture module 140 perform a medium capture action according to the captured data. If the medium data 150 is the whole video and audio data, the data processing unit 112 stores the received clip data in a register unit 113, and after the reception of the medium data 150 is completed, the medium data 150 is provided to the medium capture module 140.

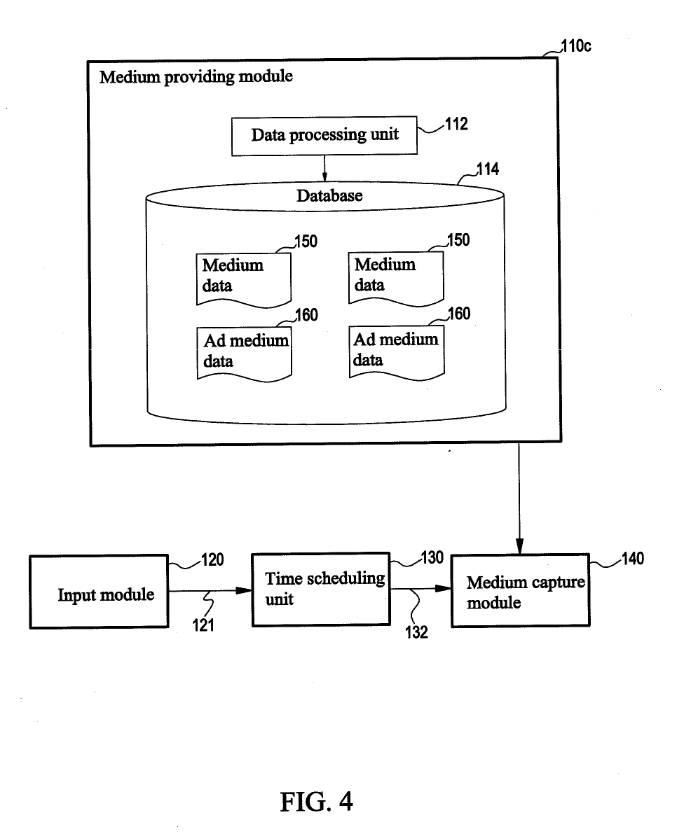

Referring to FIG. 4, a perspective diagram of a second detailed architecture of a scene scheduling system according to an embodiment of the present invention is shown. The difference between FIG. 4 and FIG. 3 lies in that, a medium providing module 110c is a database module, which has a database 114 and a data processing unit 112. The database 114 is used for storing medium data 150 and ad medium data 160. When the user designates a piece of medium data 150 through the input module 120 or a system related control interface (not shown in the drawing), the data processing unit 112 captures the medium data 150 designated by the user and the ad medium data 160 corresponding to the medium data 150 from the database 114, and provides them to the medium capture module 140.

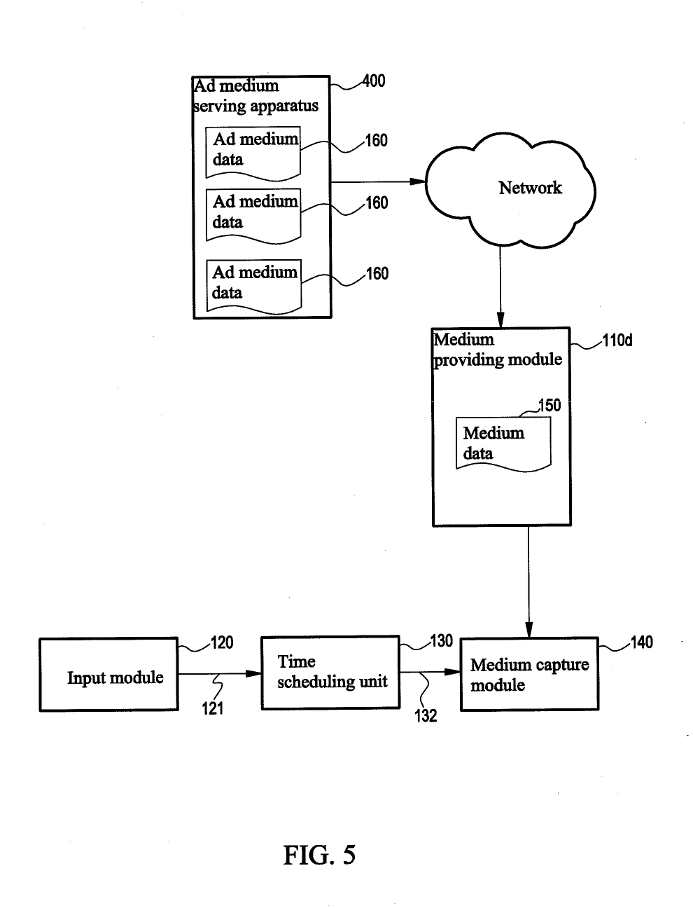

Referring to FIG. 5, a perspective diagram of a third detailed architecture of a scene scheduling system according to an embodiment of the present invention is shown. The difference between this embodiment and the foregoing embodiment lies in that, a medium providing module 110d is connected with an ad medium serving apparatus 400. This ad medium serving apparatus 400 is stored with one or several pieces of ad medium data 160. When the medium providing module 110d provides the medium data 150, all the ad medium data 160 corresponding to the medium data 150 is obtained from the ad medium serving apparatus 400, and the medium data 150 and the ad medium data 160 corresponding thereto are provided to the medium capture module 140.

Referring to FIG. 6, a perspective diagram of a fourth detailed architecture of a scene scheduling system according to an embodiment of the present invention is shown. The difference between this embodiment and the foregoing embodiment lies in that, the system further includes a storage module 500.

This storage module 500 is stored with one or more than one ad medium data list 510, the ad medium data list 510 is a group recording the ad medium data corresponding to the specific channel setting signal 121 after a capture operation that the user switches the ad or watches the ad. Much further, the ad medium data list 510 also records the play sequence of the ad medium data 160, which is recorded in the aforementioned medium play tree structure, the level and the supporting point in the tree structure of the channel setting signal 121.

When the medium capture module 140 obtains the channel setting signal 121, a capture demand condition included in the channel setting signal 121 and a list of all the ad medium data 160 of the storage module 500 are compared, so as to capture a target list. The ad medium data 160 included in this target list is the aforementioned target ad medium data 160. Next, the medium capture module 140 captures a target media frame from the medium data 150 according to the target list.

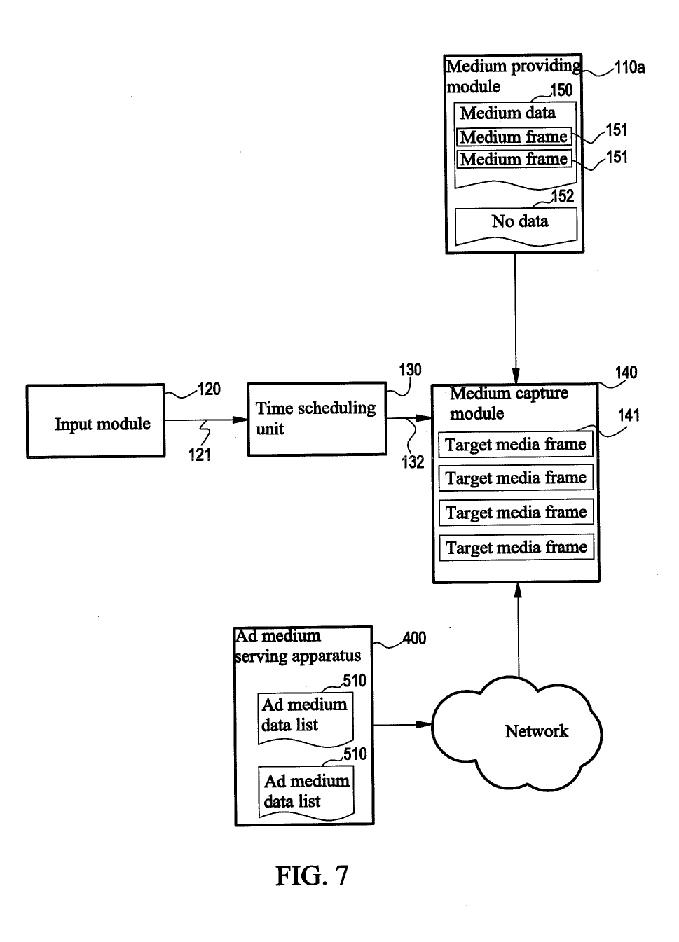

Referring to FIG. 7, a perspective diagram of a fifth detailed architecture of a scene scheduling system according to an embodiment of the present invention is shown. The difference between FIG. 7 and FIG. 5 as well as FIG. 6 lies in that, an ad medium serving apparatus 400 is connected to a medium capture module 140 in a wired or wireless connection manner. Moreover, a list of ad medium data 160 is provided by the ad medium serving apparatus 400. In this example, the ad medium serving apparatus 400 may be a third-party apparatus. Even further, the ad medium data list of this ad medium serving apparatus 400 is provided after another user performs the same or similar capture operation through software or hardware relevant to, similar or equivalent to the capture technology disclosed in the present invention.

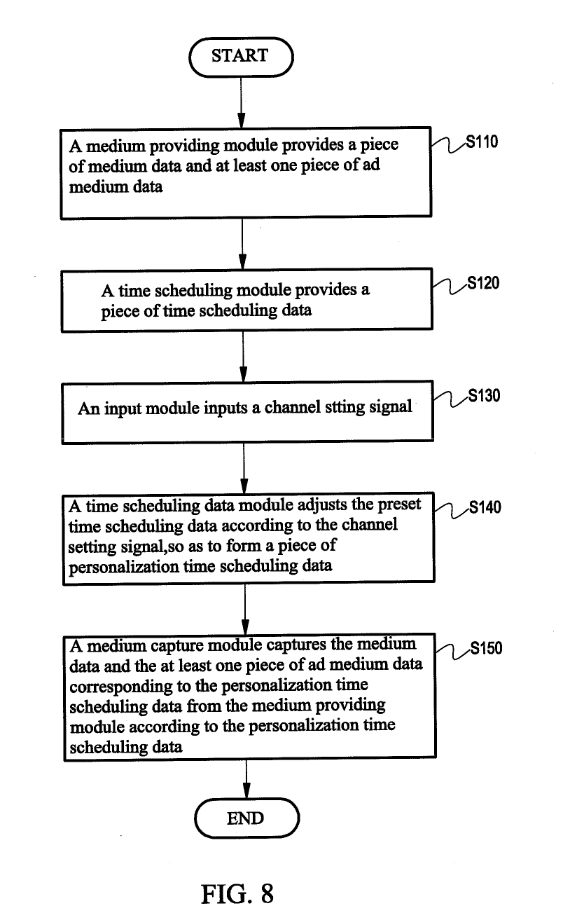

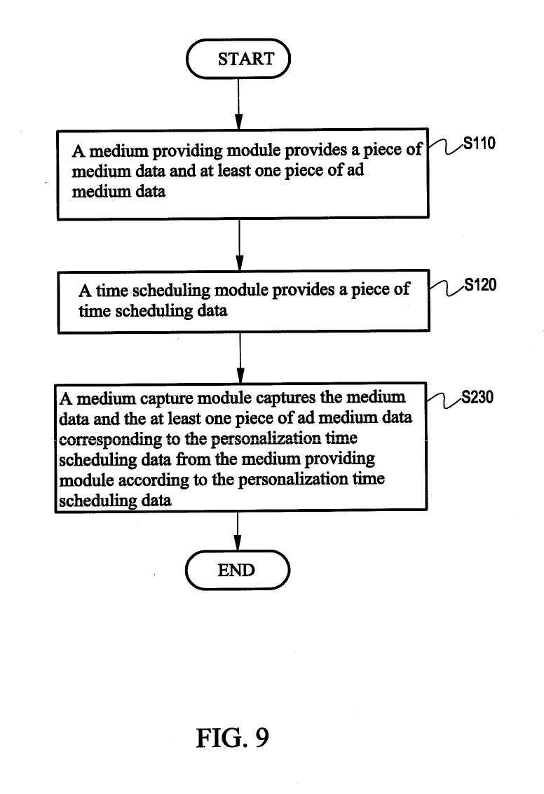

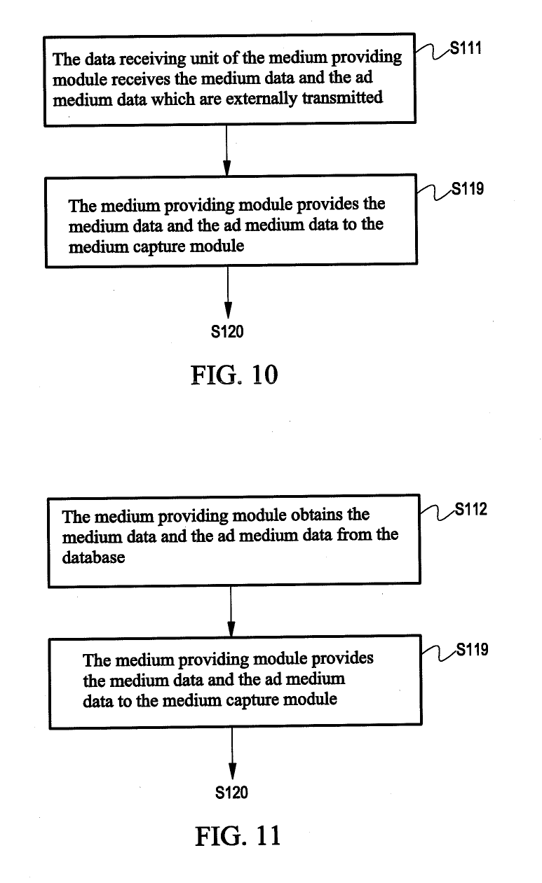

Referring to FIG. 8, a perspective flowchart corresponding to a scene scheduling method of FIG. 1 is shown, FIG. 9 shows a perspective flowchart corresponding to another scene scheduling method of FIG. 2, and FIG. 10 to FIG. 14 show a perspective diagram of a detailed process of a scene scheduling method of an embodiment of the present invention. Understanding is facilitated with reference to FIG. 1 and FIG. 7. The process of this method is as follows:

A medium providing module 110a provides a piece of medium data 150 and a piece of ad medium data 160 (step S110). According to that the medium data 150 and the ad medium data 160 are provided in different manners, the detailed implementation manner of this step also differs.

As shown in FIG. 3, the medium providing module 110b is used for being connected to an external apparatus 200, this external apparatus 200 supplies the medium data 150 and the ad medium data 160, and the medium providing module 110b is only an intermediary used for receiving and forwarding data. The detailed implementation manner of this step is shown in FIG. 10: the data receiving unit 111 of the medium providing module 110b receives the medium data 150 and the ad medium data 160 which are externally transmitted (step S111). The medium providing module 110b provides the medium data 150 and the ad medium data 160 to the medium capture module 140 (step S119).

As shown in FIG. 4, the medium providing module 110c includes a database 114, which is used for storing the medium data 150 and the ad medium data 160. The detailed implementation manner of this step is shown in FIG. 11: the medium providing module 110c obtains the medium data 150 and the ad medium data 160 from the database 114 (step S112), and provides the medium data 150 and the ad medium data 160 to the medium capture module 140 (step S119).

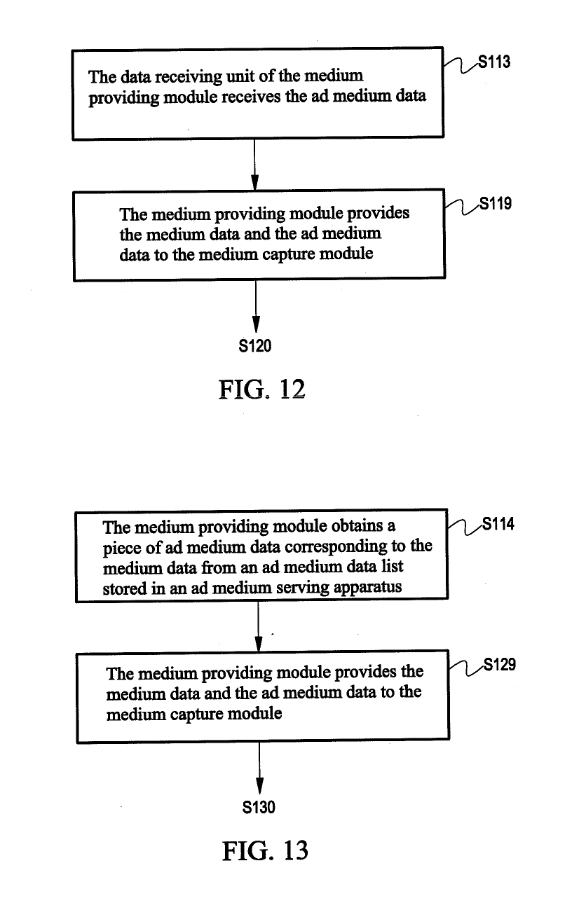

As shown in FIG. 5, a medium providing module 110d is connected with an ad medium serving apparatus 400. This ad medium serving apparatus 400 is stored with one or several pieces of ad medium data 160. The detailed implementation manner of this step is shown in FIG. 12: when the medium providing module 110d provides the medium data 150, all the ad medium data 160 corresponding to the medium data 150 is obtained from the ad medium data serving apparatus 400 (step S113), and the medium data 150 and the ad medium data 160 are provided to the medium capture module 140 (step S119).

A medium capture module 140, according to that a channel setting signal 121 is compared with each piece of the ad medium data 160, finds a piece of target ad medium data 160 matching the channel setting signal 121. According to that the medium data 150 and the ad medium data 160 are provided in different manners, the detailed implementation manner of this step also differs.

As shown in FIG. 6, the medium capture module 140 is connected to a storage module 500, which is stored with the aforementioned ad medium data list 510. The detailed implementation manner of this step is shown in FIG. 11: the medium capture module 140 obtains a target list corresponding to the channel setting signal 121 from each ad medium data list 510 stored in the storage module 500 (step S113). The medium capture module 140 obtains the target ad medium data 160 from each piece of the ad medium data 160 according to the target list (step S114).

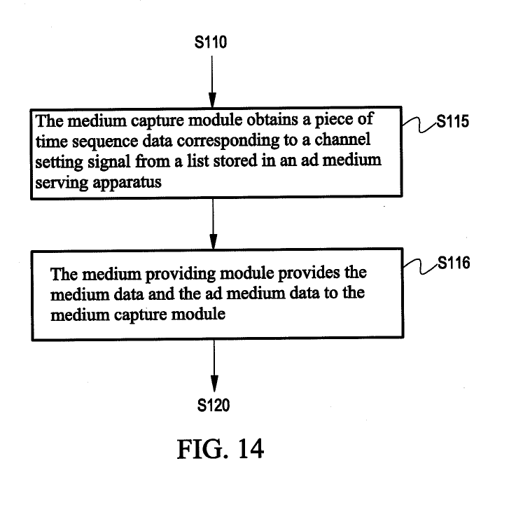

As shown in FIG. 7, an ad medium serving apparatus 400 is connected to a medium capture module 140. The detailed implementation manner of this step is shown in FIG. 14. However, the difference between the process shown in FIG. 7 and that shown in FIG. 11 lies in that, in step S115, each list of the ad medium data 160 is stored in the ad medium serving apparatus 400 serving as a third-party network apparatus.

The medium capture module 140 captures a target media frame corresponding to the target ad medium data 160 from the medium data 150. As described above, the medium capture module 140 compares a capture demand condition of the channel setting signal 121 and each piece of ad medium data 160, so as to obtain more than one piece of target ad medium data 160, and then captures all target media frames corresponding to the target ad medium data 160 from the obtained medium data 150.

However, the channel setting signal 121 may not merely include one capture demand condition, and may also include various different capture demand conditions. The medium capture module 140 captures multiple media frame groups from the medium data 150 according to each capture demand condition. Even further, the medium capture module 140 constructs each captured target media frame into one or more self-built media according to the channel setting signal 121. Also, alternatively, the medium capture module 140 constructs the target media frame or the media frame group formed of a target media frame into a play medium conforming to user demands.

This method further includes: the medium capture module 140 may construct each target media frame corresponding to each capture demand condition into a medium play tree structure according to the data dependence, the data attribute and the data hierarchy of each capture demand condition.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A scene scheduling system, comprising:
a medium providing module, used for providing a piece of medium data and a piece of ad medium data;
an input module, used for inputting a channel setting signal;
a time scheduling unit, for providing a piece of preset time scheduling data, and adjusting the preset time scheduling data according to the channel setting signal, so as to form a piece of personalization time scheduling data; and
a medium capture module, used for capturing the medium data and the piece of ad medium data corresponding to the channel setting signal and the personalization time scheduling data from the medium providing module according to the personalization time scheduling data.

2. The scene scheduling system according to claim 1, wherein in the preset time scheduling data, play time of the medium data and play time of the piece of ad medium data each amount to a preset play time proportion.

3. The scene scheduling system according to claim 1, wherein in the personalization time scheduling data, play time of the medium data and play time of the piece of ad medium data each amount to a preset play time proportion.

4. The scene scheduling system according to claim 1, wherein the personalization time scheduling data comprises a front end personalization time sequence and a rear end personalization time sequence, and in the front end personalization time sequence, the medium capture module only captures the medium data corresponding to the personalization time scheduling data.

5. The scene scheduling system according to claim 1, wherein the medium providing module comprises a data receiving unit, which is used for receiving the medium data transmitted externally and providing the medium data to the medium capture module.

6. The scene scheduling system according to claim 1, wherein the medium providing module comprises a database, which is used for storing the medium data and the piece of ad medium data.

7. The scene scheduling system according to claim 1, further comprising: an ad medium serving apparatus connected to the medium providing module, wherein when the medium providing module provides the ad medium data, each piece of the ad medium data corresponding the medium data is obtained from the ad medium serving apparatus, so as to provide each piece of the ad medium data to the medium capture module.

8. The scene scheduling system according to claim 1, further comprising: a storage module, wherein the storage module is stored with a ad medium data list, and the medium capture module obtains a piece of time scheduling data corresponding to the channel setting signal from the storage module, obtains the piece of target ad medium data from each piece of the ad medium data according to the target list, and then captures a target media frame corresponding to the piece of target ad medium data.

9. The scene scheduling system according to claim 1, wherein the medium data is formed through a combination of several scenes, and each scene is a meaningful unit formed of multiple media frames; a source of the medium data is capable of comprising a mixing module of several channels, and as far as respective programs in the channels are concerned, a scene is used as the minimum unit of the programs.

10. The scene scheduling system according to claim 1, wherein the ad medium has several ad packages, each ad package is formed through a combination of several ad units, each of the ad units comprises several ad scenes, each of the ad scenes is a meaningful unit formed of multiple media frames, and each of the media frames is formed through a combination of more than one piece of metadata.

11. The scene scheduling system according to claim 1, further comprising: an ad medium serving apparatus connected to the medium capture module, wherein the ad medium serving apparatus is stored with a ad medium data list, and the medium capture module obtains a target list corresponding to the channel setting signal from the ad medium serving apparatus, obtains the piece of target ad medium data from each piece of the ad medium data, and then captures a target media frame corresponding to the piece of target ad medium data.

12. A scene scheduling method, comprising:
providing, by a medium providing module, a piece of medium data and a piece of ad medium data;
providing, by a time scheduling data module, a piece of preset time scheduling data;
inputting, by an input module, a channel setting signal;
adjusting, by the time scheduling data module, the preset time scheduling data according to the channel setting signal, so as to form a piece of personalization time scheduling data; and
capturing, by a medium capture module, the medium data and the piece of ad medium data corresponding to the personalization time scheduling data from the medium providing module according to the personalization time scheduling data.

13. The scene scheduling method according to claim 12, wherein the step of providing, by a medium providing module, a piece of medium data and a piece of ad medium data comprises:
receiving, by a data receiving unit of the medium providing module, the medium data and the ad medium data which are externally transmitted; and
providing, by the medium providing module, the medium data and the ad medium data to the medium capture module.

14. The scene scheduling method according to claim 12, wherein the step of providing, by a medium providing module, a piece of medium data and a piece of ad medium data comprises:
obtaining the medium data and the ad medium data from a database of the medium providing module; and
providing the medium data and the ad medium data to the medium capture module.

15. The scene scheduling method according to claim 12, wherein the step of providing, by a medium providing module, a piece of medium data and a piece of ad medium data comprises:
obtaining, by the medium providing module, the ad medium data corresponding to the medium data from an ad medium data serving apparatus; and
providing, by the medium providing module, the medium data and the ad medium data to the medium capture module.

16. The scene scheduling method according to claim 12, wherein the step of capturing, by a medium capturing module, the medium data and the piece of ad medium data corresponding to the personalization time scheduling data from the medium providing module according to the personalization time scheduling data further comprises:
obtaining, by the medium capture module, a piece of time scheduling data corresponding to the channel setting signal from a ad medium data list, wherein the ad medium data list is stored in a storage module; and
obtaining, by the medium capture module, the piece of target ad medium data from each piece of the ad medium data according to the target list.

17. The scene scheduling method according to claim 12, wherein the step of capturing, by a medium capturing module, the medium data and the piece of ad medium data corresponding to the personalization time scheduling data from the medium providing module according to the personalization time scheduling data further comprises:
obtaining, by the medium capture module, a target list corresponding to the channel setting signal from a ad medium data list, wherein the ad medium data list is stored in an ad medium data serving apparatus connected to the medium capture module; and
obtaining, by the medium capture module, the piece of target ad medium data from each piece of the ad medium data according to the target list.

18. A recording medium, stored with a program code readable to an electronic apparatus, wherein when the electronic apparatus reads the program code, a scene scheduling method is executed, and the method comprises the following steps of:
providing, by a medium providing module, a piece of medium data and a piece of ad medium data;
providing, by a time scheduling data module, a piece of preset time scheduling data;
inputting, by an input module, a channel setting signal;
adjusting, by the time scheduling data module, the preset time scheduling data according to the channel setting signal, so as to form a piece of personalization time scheduling data; and
capturing, by a medium capture module, the medium data and the piece of ad medium data corresponding to the personalization time scheduling data from the medium providing module according to the personalization time scheduling data.

19. The recording medium according to claim 18, wherein the step of providing, by a medium providing module, a piece of medium data and a piece of ad medium data comprised in the method comprises:
continuously receiving, by a data receiving unit of the medium providing module, media frames and the ad medium data corresponding to each media frame which are externally transmitted; and
providing the media frames and the ad medium data corresponding to each media frame to the medium capture module.

20. The recording medium according to claim 18, wherein the step of providing, by a medium providing module, a piece of medium data and a piece of ad medium data comprised in the method comprises:
obtaining the media frames and the ad medium data corresponding to each media frame from a database of the medium providing module; and
providing the media frames and the ad medium data corresponding to each media frame to the medium capture module.

21. The recording medium according to claim 18, wherein the step of providing, by a medium providing module, a piece of medium data and a piece of ad medium data comprised in the method comprises:
obtaining, by the medium providing module, the ad medium data corresponding to each media frame from an ad medium data serving apparatus; and
providing, by the medium providing module, the media frames and the ad medium data corresponding to each media frame to the medium capture module.

22. The recording medium according to claim 18, wherein the step of capturing, by a medium capturing module, the medium data and the piece of ad medium data corresponding to the personalization time scheduling data from the medium providing module according to the personalization time scheduling data further comprises:
obtaining, by the medium capture module, a target list corresponding to the channel setting signal from a ad medium data list, wherein the ad medium data list is stored in a storage module, and each ad medium data list comprises a plurality of ad medium data sequences; and
obtaining, by the medium capture module, the piece of target ad medium data from each piece of the ad medium data according to the target list.

23. The recording medium according to claim 18, wherein the step of capturing, by a medium capturing module, the medium data and the piece of ad medium data corresponding to the personalization time scheduling data from the medium providing module according to the personalization time scheduling data further comprises:
obtaining, by the medium capture module, a target list corresponding to the channel setting signal from a ad medium data list, wherein the ad medium data list is stored in an ad medium data serving apparatus connected to the medium capture module, and each ad medium data list comprises a plurality of ad medium data sequences; and
obtaining, by the medium capture module, the a piece of target ad medium data from each piece of the ad medium data according to the target list.
